(19) United States
(12) Patent Application Publication
(10) Pub. No.: US 2012/0016733 A1
(43) Pub. Date: Jan. 19, 2012

(54) SYSTEM AND METHOD FOR CORRELATING ELECTRONIC ADVERTISEMENTS PRESENTED TO CONSUMERS ON COMPUTING DEVICES WITH CONSUMER VISITS TO RETAIL ENVIRONMENTS

(75) Inventors: Timothy Belvin, Woodinville, WA (US); Timothy B. Morton, Kirkland, WA (US)

(73) Assignee: Visible Brands, Inc., San Francisco, CA (US)

(21) Appl. No.: 12/835,604

(22) Filed: Jul. 13, 2010

(51) Int. Cl. G06Q 30/00

(52) U.S. Cl. 705/14.41; 705/14.58

(57) ABSTRACT

A system and method for tracking advertisements that are electronically presented to consumers on computing devices and correlating the presented advertisements with consumer visits to retail environments. Using a computing device, a consumer that accesses electronic content may be presented with advertisements. Presented electronic advertisements include a first script that is executed when an advertisement is displayed in order to transmit a presentation message to the monitoring system. The presentation message is used by the monitoring system to track the identity of advertisements that are presented to consumers. When consumers visit a retail establishment, an advertising system utilizes the information about the electronic advertisements that have been presented to consumers in order to target advertising content to consumers on a network of display devices that are located at the retail establishment. Consumers may be targeted on an individual or group basis.

### BACKGROUND

On a daily basis, consumers are bombarded with advertising in a variety of different forms and channels. In the online world, such as when surfing the World Wide Web, consumers are presented with a variety of textual and visual advertisements that attempt to entice the consumer to purchase the goods or services of advertisers. One advantage of advertising online is that the presented advertisements may be targeted to consumers. Advertisements that are displayed to consumers may be generally targeted based on the content with which the advertisement is displayed. For example, advertisers may purchase advertising slots on a particular website in order to reach consumers that frequent that website. Advertisements that are displayed to consumers may also be targeted using information known about a consumer, such as based on the past purchase behavior of the consumer, browsing behavior of the consumer, or known demographic information about the consumer. For example, a website may maintain a record of purchases that a consumer made through that website and allow advertisers to target specific consumers based on the past purchases made by a consumer. Advertising to consumers in the online domain has proven to be a very effective way for advertisers to reach consumers because of the targeting that may be performed.

As effective as advertisements in the online domain have been, however, their reach has generally been limited to online promotions. That is, advertisers have been unable to translate the successful strategies used to target advertisements online into the real world, bricks-and-mortar, domain. Advertisers have failed to do so for a variety of reasons. For example, although consumers may be readily tracked while performing actions online, consumers are not so-readily tracked in the real world. Identifying and targeting consumers as they shop within a retail environment has proven to be a challenging problem. Moreover, even if consumers could be tracked in the real world, there has been no effective way to link information from the online domain to the real-world domain. These two domains have therefore remained separate, with each domain targeted by advertisers using strategies that are unique to that domain.

### BRIEF DESCRIPTION OF THE DRAWINGS

FIG. 1 is a representative environment in which a monitoring system operates to allow the correlation of electronic advertisements displayed to consumers with consumer visits to retail environments.

FIG. 2 is a block diagram of the monitoring system for tracking electronic advertisements displayed to consumers and allowing such advertisements to be correlated with consumer visits to retail environments.

FIG. 3 is a representative screenshot of a web page that displays electronic advertisements to a consumer.

FIG. 4A-4B is a flow chart of a process to construct and transmit a presentation message to the monitoring system when an electronic advertisement is presented to a consumer.

FIG. 5A-5B is a flow chart of a process to interpret a presentation message that is received when a consumer or a consumer household is presented an electronic advertisement.

FIG. 6A is a representative data table that is populated with received information about electronic advertisements that have been presented to consumers.

FIG. 6B is a representative data table used to maintain the identity of consumers in consumer households.

FIG. 7 is a representative retail environment having an advertising system and display devices that are utilized to display targeted advertising content to consumers in the retail environment.

FIG. 8 is a flow chart of a process to request information about previously-delivered electronic advertisements to consumers for purposes of targeting advertisements to consumers in retail environments.

FIG. 9 is a representative data table used to maintain aggregate statistics about advertisements presented to consumers within particular geographic areas.

### DETAILED DESCRIPTION

A system and method for tracking advertisements that are electronically presented to consumers on computing devices and correlating the presented advertisements with consumer visits to retail environments is disclosed (hereinafter the “system” or “monitoring system”). Using a computing device, a consumer that accesses electronic content may be presented with one or more advertisements in association with the content. Electronic advertisements that are presented to a consumer include a script that is executed in conjunction with the display of the advertisement. When the script is executed (i.e., when triggered by the selection of an advertisement, by the consumer navigating away from the advertisement and accessed electronic content to new electronic content and a new advertisement, or by the advertisement otherwise being replaced with a new advertisement), a presentation message is transmitted to the monitoring system indicating that the advertisement has been presented. The presentation message contains information that reflects the identity of the advertisement, the identity of the computing device (if available) on which the advertisement was presented, and indicia reflecting the physical location of the computing device. The identity of the computing device (or of a user of the computing device) may be reflected by a cookie that is stored on the device or an address associated with the device. The location of the computing device may be reflected by the IP address of the device, the geographic coordinates of the device, or other measure of the location of the device, etc. The presentation message is used by the monitoring system to track the identity of advertisements that are presented to specific consumers or groups of consumers within a household. That is, based on the received presentation messages, the monitoring system is able to use the identity of the computing device and/or the location of the computing device to identify consumers or consumer households to which the advertisement was explicitly or likely presented. The monitoring system thereby constructs a profile of those electronic advertisements that were presented to a particular consumer.

When consumers visit a retail establishment, the monitoring system utilizes the information about the electronic advertisements that have been presented to consumers in the same and surrounding geographic areas in order to target advertising content to consumers on a network of display devices that are located at the retail establishment. An advertising system for the delivery of advertising content to consumers in a retail environment is described in U.S. patent application Ser. No. 12/557,383, filed Sep. 10, 2009, and entitled “SYSTEM AND METHOD FOR THE SERVICE OF ADVERTISING CONTENT TO A CONSUMER BASED ON THE DETECTION OF ZONE EVENTS IN A RETAIL ENVIRONMENT,” which is incorporated herein by reference in its entirety. If a consumer is specifically identified by the monitoring system as having been presented one or more electronic advertisements, the advertising system may use the record of the presented advertisements to target the same or complementary advertising content to the consumer when the consumer is in the retail establishment. If a consumer is not specifically identified by the monitoring system as having been presented one or more electronic advertisements, the advertising system uses the record of the electronic advertisements that have been presented to consumers in the same or surrounding geographic area of the retail environment. That is, the advertising system uses the record of advertisements that were presented to the surrounding populace in order to target the same or complementary advertising content to the unidentified consumer. By allowing advertising content to be targeted to consumers based on prior electronic advertisements that consumers were exposed to while operating a computing device, the monitoring system improves the efficacy of the displayed advertisements and provides greater benefit to consumers and advertisers.

In some embodiments, the presentation message also contains an indication of whether the consumer selected or otherwise expressed an interest in the advertisement. The indication of interest may be inferred by the consumer's interaction with the advertisement. The presentation message may also contain context information that is associated with the display of the advertisement to the consumer. The context information may include the URI or URL associated with the content being viewed by the consumer, or a record of the past browsing behavior immediately preceding the presentation of the advertisement. The indication of interest and the context information may be used by the monitoring system to better judge the reaction to, and effectiveness of, the presented advertisement.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

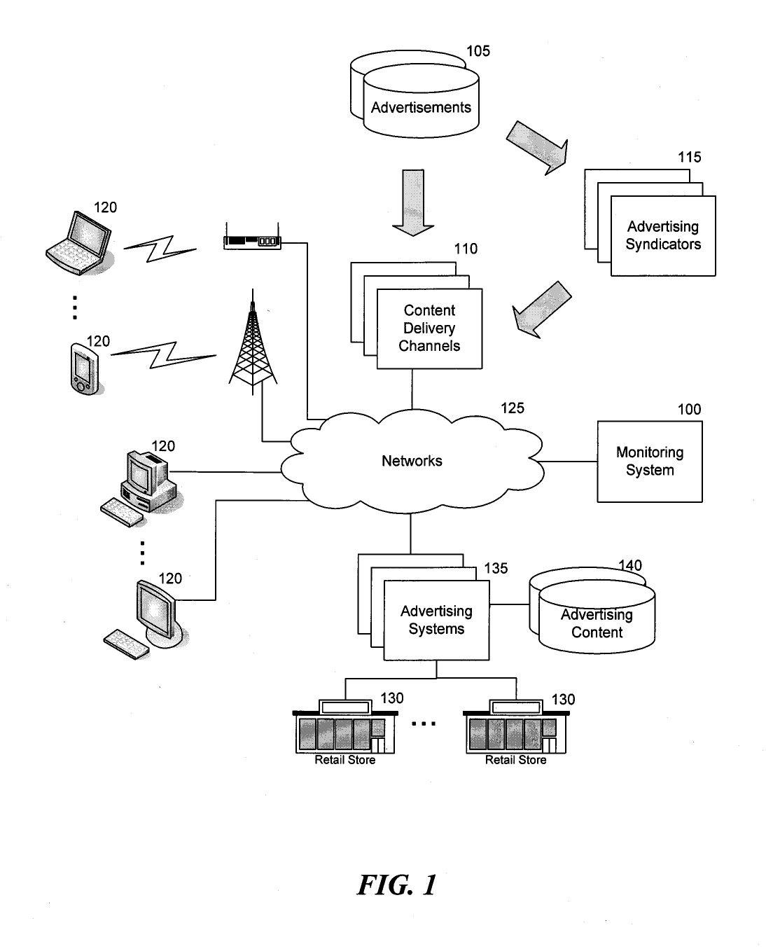

FIG. 1 is a representative environment in which a monitoring system 100 operates for tracking electronic advertisements presented to consumers and correlating the presented advertisements with subsequent consumer visits to retail environments. Electronic advertisements 105 may be provided by advertisers directly to content delivery channels 110, such as content sites (e.g., websites) or other applications or services that provide delivery of electronic content to consumers (e.g., email services, mapping services, review services, etc.). Electronic advertisements 105 may also be provided by advertisers indirectly to content delivery channels 110, such as through advertising syndicators 115 (e.g., GOOGLE ADSENSE, COUPONS.COM, VALASSIS, YAHOO!, AOL, MSC, etc.).

Consumers may access the content and electronic advertisements available via the content delivery channels 110 using computing devices 120. Computing devices 120 include both mobile and fixed computing devices, such as smart phones, portable media players, portable gaming devices, personal computers, laptop computers, console gaming devices, televisions incorporating functionality that allows a consumer to access the World Wide Web or that can monitor advertisements presented to the consumer, or the like. The computing devices access the content delivery channels via public and private, wired and wireless, networks 125. Such networks include, for example, the Internet and other corporate, government, or personal networks.

As will be described in additional detail herein, as a consumer accesses electronic content from a content delivery channel 110, the consumer may be presented with one or more advertisements 105 with the accessed content. For each advertisement containing a script as described herein, the presentation of the advertisement to a consumer results in the sending of a presentation message from the computing device 120 to the monitoring system 100. The presentation message contains information that reflects the identity of the presented advertisement, the identity of the computing device (if available) on which the advertisement was presented, and indicia reflecting the physical location of the computing device. If the consumer also expresses an interest in an advertisement, such as by hovering over or selecting the advertisement, the presentation message also contains an indication that the consumer expressed such an interest in the advertisement. In some embodiments, the presentation message may also contain consumer-specific information that is associated with the consumer, such as an indication of past browsing behavior immediately preceding selecting the advertisement, a record of recent actions taken by the consumer, or any other action that a consumer consents to have shared with the monitoring system 100.

By receiving the presentation messages, the monitoring system 100 builds and maintains a record of electronic advertisements that have been presented to consumers. If information is available that identifies the particular computing device on which an electronic advertisement was presented, the advertisement is correlated with the specific computing device. If information is not available to identify the particular computing device on which an electronic advertisement was presented, the advertisement is correlated first with a geographic area that is associated with the computing device, and then to households that are contained within that geographic area.

At the same time that the monitoring system 100 receives indications of electronic advertisements that are being presented to consumers, consumers will visit various retail environments 130 to purchase goods or services from those establishments. A retail environment may be any environment in which consumers purchase products or services, such as a grocery store, a drug store, an office supply store, a hardware store, an auto parts store, etc. An advertising system 135 may be deployed in each retail environment to deliver advertising content to consumers that are present in the environment. A representative advertising system for the delivery of advertising content to consumers in a retail environment is described in U.S. patent application Ser. No. 12/557,383, filed Sep. 10, 2009, and entitled “SYSTEM AND METHOD FOR THE SERVICE OF ADVERTISING CONTENT TO A CONSUMER BASED ON THE DETECTION OF ZONE EVENTS IN A RETAIL ENVIRONMENT,” which is incorporated herein by reference in its entirety. In some cases, the advertising system 135 that is deployed in a retail environment is capable of individually identifying the consumer within the retail environment. Methods for identifying consumers in a retail establishment are described in the aforementioned '383 application. Methods for identifying consumers in the retail establishment are also described in U.S. patent application Ser. No. 12/621,414, filed Nov. 18, 2009, and entitled “SYSTEM AND METHOD FOR THE CORRELATION OF MOBILE DEVICES WITH MARKERS USED BY A CONTENT DELIVERY SYSTEM IN A RETAIL ENVIRONMENT,” which is incorporated herein by reference in its entirety. In other cases, the advertising system 135 that is deployed in a retail environment is unable to individually identify consumers in the retail environment. Regardless of whether the advertising system 135 is able to identify consumers in the retail environment, as will be described herein, the monitoring system 100 provides information to the advertising system 135 to allow the advertising system to better target advertising content to consumers.

An advertising system 135 in a retail environment sends requests to the monitoring system 100 for information that may be used to better target advertising content to consumers in the retail environment. The advertising system 135 may send a general request for information that is applicable to consumers that typically visit the retail establishment. The monitoring system 100 responds to the request by identifying and providing data characterizing advertisements presented to one or more consumers that are in the same or surrounding geographic areas to the retail environment. That is, the monitoring system provides data that characterizes those electronic advertisements to which the consumers that frequent the retail environment were likely exposed. While the monitoring system 100 is unable to accurately assess whether the particular consumers in the retail environment were actually exposed to the electronic advertisements, the statistical likelihood is high that at least some of the consumers were exposed to the advertisements at a rate that is proportional to the measured exposure rate in the surrounding community. When the advertising system 135 receives data that characterizes recent electronic advertisements that were presented to consumers from the same or similar geography, the advertising system uses the received data to select similar or complementary advertising content from stored advertising content 140 for display to consumers. For example, if the advertising system 135 receives data from the monitoring system 100 that indicates that a significant amount of COCA-COLA advertisements have recently been presented to consumers within the neighborhoods surrounding the retail environment 130, the advertising system 135 may elect to select complementary advertising content such as advertisements for potato chips or pretzels to present to consumers in the retail environment. Such a display of complementary advertising content may boost the sale of the advertised products. Moreover, the advertising system 135 may elect to defer the display of PEPSI advertising content to consumers, to avoid having to compete with the ongoing campaign associated with COCA-COLA.

The advertising system 135 may alternatively send to the monitoring system 100 a specific request for information that is applicable to an identified consumer or a consumer household that visits the retail establishment. The monitoring system 100 responds to the request by identifying and providing data characterizing advertisements presented to the identified consumer or consumer household. That is, the monitoring system provides data that characterizes those electronic advertisements that the identified consumer or consumers in the household were recently exposed to. When the advertising system 135 receives data that characterizes the recent electronic advertisements that were presented to identified consumer or consumers, the advertising system uses the received data to select similar or complementary advertising content from stored advertising content 140 for presentation to consumers. For example, if the advertising system 135 receives data form the monitoring system 100 that indicates that a consumer had recently been presented with an advertisement for PLANTERS peanuts, the advertising system 135 may show the consumer PLANTERS peanuts advertising content in the retail environment in order to reinforce the brand message that the consumer had recently received.

By allowing advertising content to be targeted to consumers based on prior electronic advertisements that consumers were exposed to while operating computing devices 120, the monitoring system 100 improves the efficacy of the displayed advertisements and provides greater benefit to consumers and advertisers. Moreover, the monitoring system 100 provides a link between the online world and the bricks-and-mortar world that didn't previously exist. It will be appreciated that while the monitoring system 100 and advertising system 135 are depicted as separate systems in FIG. 1, the functionality of the two systems may be integrated into a single system or distributed across multiple systems.

In some embodiments, the monitoring system 100 allows a desired sequence of advertisements to be presented to consumers on computing devices 120 and in retail establishments. For example, the monitoring system 100 may detect that a consumer using a computing device has been presented with two advertisements in a four-part advertising series. When the consumer enters the retail establishment, the advertising system 135 receives an indication of the two advertisements that have already been presented to the consumer and may then elect to present the remaining two-parts of advertising content to the consumer as the consumer shops in the retail establishment. The consumer is thereby presented with the entire four-part series as desired by the advertiser.

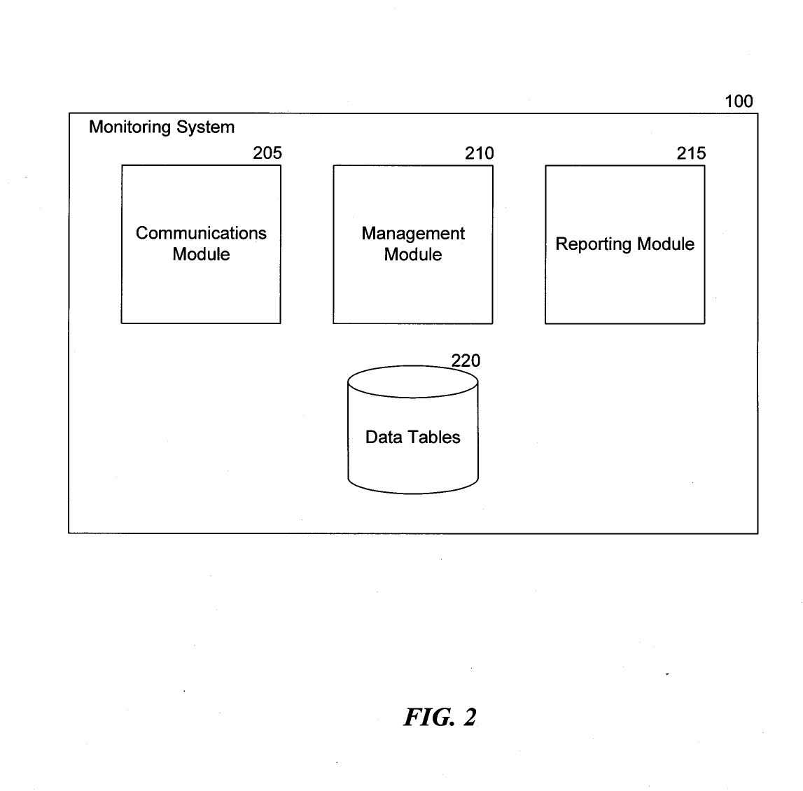

FIG. 2 is a block diagram of the monitoring system 100 for tracking electronic advertisements displayed to consumers and allowing such advertisements to be correlated with consumer visits to retail environments. The monitoring system 100 comprises a communications module 205, a management module 210, and a reporting module 215. The communications module 205 receives inbound communications and sends outbound communications. For example, the communications module 205 receives presentation messages when electronic advertisements are displayed and/or selected on consumer computing devices. The communications module 205 also transmits data that is responsive to inquiries from advertising systems 135. The management module 210 interprets all received messages from consumer computing devices and stores information characterizing the presented advertisements (including the households in the geographic area where such advertisements were presented) in one or more data tables 220. “Data tables” is used herein in the generic sense to refer to any area that allows data to be stored in a structured and accessible fashion using such applications or constructs as databases, tables, linked lists, arrays, and so on. The reporting module 215 analyzes the stored data tables 220 to generate reports and data that are responsive to inquiries that are received from advertising systems 135. The reporting module is, for example, capable of providing data which characterizes advertisements that have been presented to an individual consumer or a consumer household as defined in a query from an advertising system. The reporting module 215 may generate such reports in response to a query (i.e., in a “pull” fashion). Alternatively or in addition, the reporting module 215 may periodically or continuously generate reports that are sent to advertising systems 135 (i.e., in a “push” fashion).

The monitoring system 100 may be implemented on any computing system or device. Suitable computing systems or devices include personal computers, server computers, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

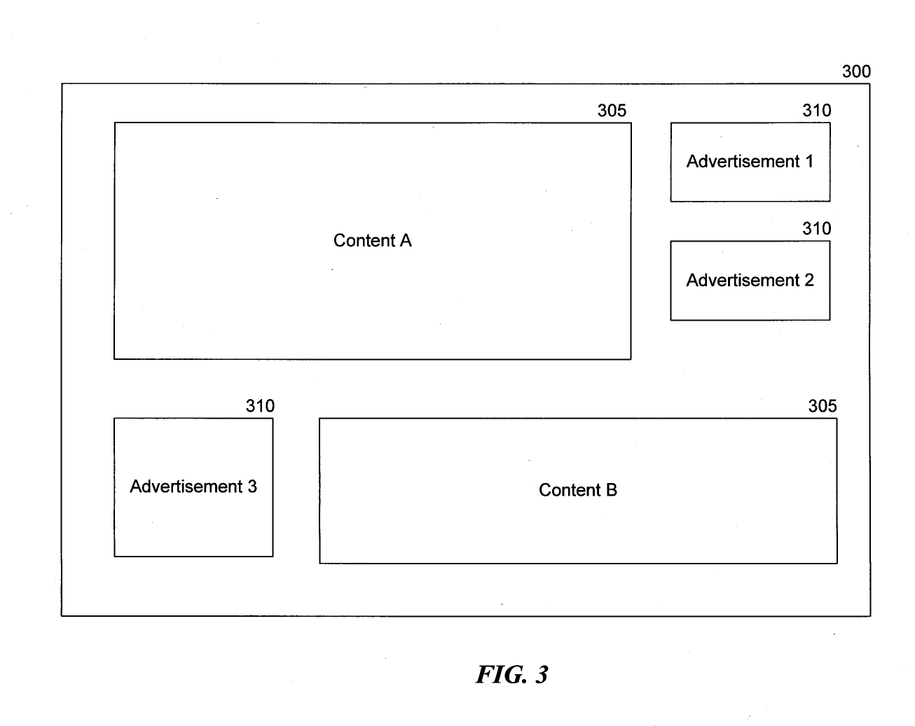

As previously noted, the monitoring system 100 receives a presentation message when an electronic advertisement is presented to a consumer on a computing device. FIG. 3 is a representative screenshot of a webpage 300 that might be presented to a consumer. The webpage 300 contains one or more regions 305 containing text, images, or video that may be of interest to a consumer. For example, if the webpage is operated by a magazine or a newspaper, the regions may contain articles that are of interest to the consumer. As another example, if the webpage is managed by a retailer, the regions 305 may contain product descriptions and a mechanism to purchase the displayed products. In addition to the content that is displayed in regions 305, one or more electronic advertisements 310 are displayed to the consumer. The electronic advertisements may be presented in a variety or formats, including text ads, banner ads, video ads, pop-up ads, pop-under ads, etc. The electronic advertisements may be targeted to the consumer that is viewing the webpage, or the advertisements may be randomly selected for the consumer.

In order for the monitoring system 100 to be notified when an electronic advertisement 310 is presented to a consumer, a script is incorporated into each advertisement and executed by the computing device 120 on which the advertisement is presented. When the advertisement is presented to the consumer and the corresponding script executed, a presentation message is sent to the monitoring system 100 to report the display of the advertisement. The presentation message contains information that reflects the identity of the advertisement, the identity of the computing device (if available) on which the advertisement was presented, indicia reflecting the physical location of the computing device, and an indication of whether the consumer selected or otherwise expressed an interest in the advertisement.

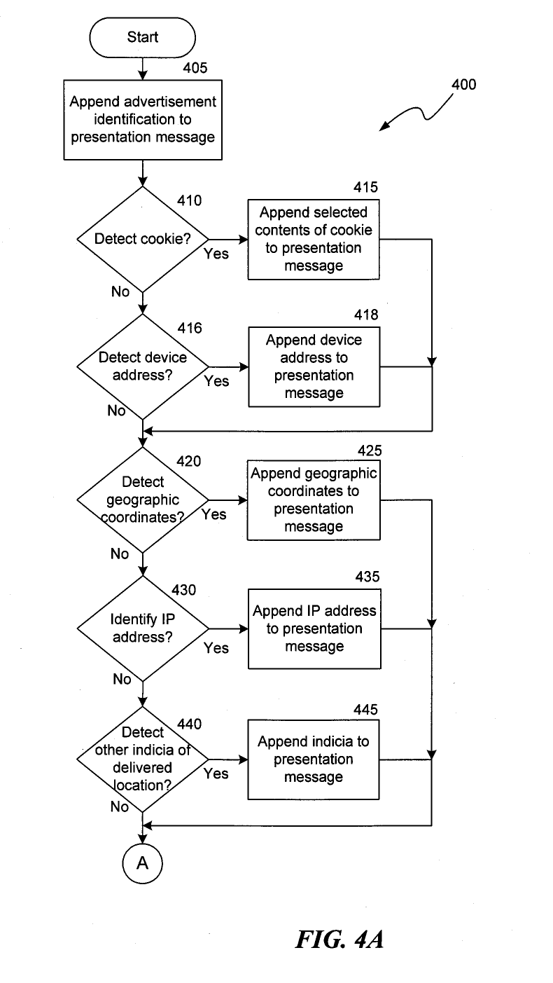

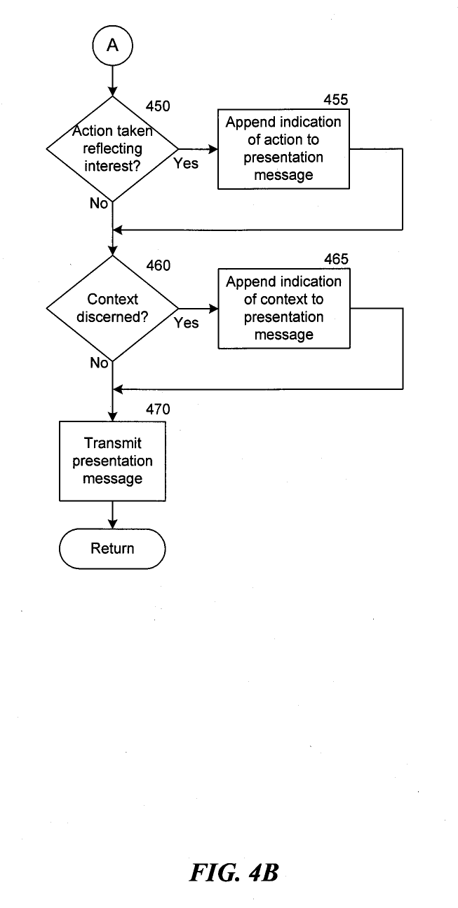

FIG. 4A-4B is a flow chart of a process 400 to construct and transmit a presentation message when an electronic advertisement is presented to a consumer. The process 400 is triggered when a consumer selects an advertisement or navigates away from an advertisement that has been displayed on a computing device 120. As used herein, “navigating away” means that the consumer has switched from a view of the advertisement to a view that doesn't contain the advertisement. Navigating away may occur, for example, when the consumer moves from one webpage to another webpage, when a consumer closes an email that contains an advertisement, when a consumer closes an application in which an advertisement is being presented, when an advertisement is replaced with a new advertisement, etc. Because the process 400 seeks to report any actions that a consumer might take with respect to an advertisement, the process for transmitting a presentation message occurs either after the consumer performs the action (e.g., selects or otherwise shows interest in an advertisement) or after the consumer transitions to a new activity that does not allow an action to be taken with respect to the advertisement. The process 400 is implemented by a script that is delivered in conjunction with an advertisement to a consumer's computing device, and executed by itself or in conjunction with other piece of code that is resident on the computing device of the consumer.

When the process 400 is executed, a presentation message is built for transmission to the monitoring system 100. At a block 405, the script causes the presentation message to be appended with a code or other identifier that identifies the advertisement that was presented to the consumer. The identifier is used by the monitoring system 100 to record which advertisement was delivered to the consumer or consumer household, thereby allowing the monitoring system to track advertising impressions.

After appending an indication of the particular advertisement to the presentation message, the script appends information that identifies the computing device on which the advertisement was delivered as well as the location of the computing device. At a decision block 410, a test is made by the script as to whether there is a cookie associated with the monitoring system 100 that was previously stored on the computing device. If a cookie is detected on the computing device, processing continues to a block 415 where selected contents from the cookie are appended to the presentation message. For example, a unique user identifier from the cookie may be appended to the presentation message. Processing then continues to a block 470.

If a cookie is not detected on the computing system, at a decision block 416 a test is made by the script to determine whether a device address, such as a Media Access Control (MAC) address, an International Mobile Subscriber Identity (“IMSI”), an International Mobile Equipment Identity (“IMEI”), a serial number, or the like, can be detected. If a device address can be detected, processing continues to a block 418 where the detected device address is appended to the presentation message. The device address serves to identify a computing device when a cookie has not previously been stored on the computing device, or in those circumstances in which the computing device does not support or is disabled to support cookies. Processing then continues to block 470.

If a cookie or device address is not detected, at decision block 420 a test is made to determine whether geographic coordinates associated with the computing device are available. For example, if the computing device is a mobile device, the script may be able to access the current or any preceding latitude and longitude of the mobile device. If the geographic coordinates associated with the computing device can be identified, at a block 425 the geographic coordinates are appended to the presentation message. For example, the latitude and longitude of the computing device may be appended to the presentation message. Processing then continues to a block 470.

At decision block 430, a test is made by the script to determine whether the IP address associated with the computing device can be identified. If the IP address associated with the computing device can be identified, at a block 435 the IP address is appended to the presentation message. Processing then continues to a block 470.

At decision block 440, a test is made by the script to determine whether any other indicia of location are available for the mobile device. Such indicia may include, for example, a stored address of a consumer, a CTI (cell tower identifier) reflecting a cell tower that is within communication range of the computing device, etc. If any other indicia associated with the location of the computing device can be identified, at a block 445 the indicia are appended to the presentation message. Processing then continues to a block 450.

At a decision block 450, the script determines whether any action reflecting an indication of interest was taken by the consumer during the period that the advertisement was presented to the consumer. Such action may be the consumer's selection of the advertisement by clicking-on the advertisement. As another example, the action may be the consumer's hovering-over the advertisement with a cursor or other pointing-device, thereby causing the advertisement to change by expanding, playing a video, revealing additional information, etc. As still another example, if eye tracking capabilities are built into the computing device, the action may be the focus of the consumer's eyes in a direction towards the advertisement for a length of time that would indicate an interest in the advertisement. If an action indicating interest in the advertisement is detected as having occurred by the script, at a block 455 an indication of the detected action is appended to the presentation message. (It will be appreciated that a consumer's selection of an advertisement may also trigger other processes, such as the direction of the consumer to a website or content that is associated with that advertisement.) Processing then continues to a block 460.

At a decision block 460, the script determines whether the context in which the advertisement was presented to the consumer can be discerned. The context may be represented, for example, by the URL (Uniform Resource Locator) or URI (Uniform Resource Identifier) of the content that is currently being viewed by the consumer. Alternatively, the context may be reflected by the historical path (as maintained in the browser history) that the consumer traversed in order to arrive at the current content. If the script is able to derive any context information about the display of the advertisement, at a block 465 an indication of the context is appended to the presentation message. Processing then continues to a block 470.

At block 470, the script transmits the presentation message to the monitoring system 100. Depending on the type of computing device and the application program which runs the script on the computing device, the presentation message will contain a sufficient level of detail to indicate to the computing device the location at which a particular advertisement was presented to one or more consumers.

The process depicted in FIG. 4A-4B is a process that may be implemented on any computing device. A script implementing process 400 may be implemented by code that is delivered in conjunction with an advertisement, by code that is previously-resident on the consumer's computing device, or by code that is both delivered to the consumer's computing device as well as previously-resident on the consumer's computing device. For example, the script may be a short segment of JavaScript that is incorporated into a webpage that is rendered by a browser application executing on the consumer's computing devicet. The following JavaScript segment in Table 1 is an example of a script that will automatically generate and send a presentation message to the monitoring system 100:

TABLE 1

<script>
var adObject = new adObject( );
adObject.currentSession = navigator.appName + “ “ +
navigator.appVersion;
adObject.location = geo_position_js.getCurrentPosition( );
adObject.postMessage( );
</script>

The example script that is delivered with the advertisement operates in conjunction with code and/or libraries that were previously delivered to the computing device via, for example, a JAR (Java Archive) file to cause a presentation message to be sent to the monitoring system. The presentation message generated by the example script contains application identification information and location information. Those skilled in the art will appreciate that additional code may be required to add additional information to the presentation message, such as information indicating actions taken by the consumer or information indicating the context of the displayed advertisement as depicted in the process flow of FIG. 4A-4B.

When the script executes on the consumer's computing device, either by itself or in conjunction with resident code that is located on the computing device, a presentation message is transmitted to the monitoring system. The following message in Table 2 is an example of such a presentation message:

TABLE 2
<impressionLog>
<currentSession id=”54212392” browser=“Microsoft Internet Explorer”
browserversion=“4.0” campaign=”AG123” family code=”CPG”
adfamily=”Breakfast Food” adid=”GM99125” loc=”123,87”/>
</impressionLog>

In the presentation message, the presented advertisement is characterized by a variety of metadata, including an advertising campaign identifier (e.g., “AG123”), a family code that characterizes the product being advertised (e.g., “CPG,” or consumer packaged goods), a more specific characterization of the product that is provided by the advertiser (e.g., “Breakfast Food”), and an advertisement identifier (e.g., “GM99125”). Additional details about the presented advertisement include the browser on which the advertisement was presented and the location of the computing device when presented. Although not shown, the presentation message may also include an indication of whether the consumer expressed an interest in the advertisement, a URI or URL of the content page on which the advertisement was displayed, and a dwell time that a consumer remained on the content page prior to selecting a different content page.

If script is delivered to computing devices in conjunction with advertisements, it will be appreciated that advertisers are incentivized to incorporate the script into each advertisement that they present because doing so allows the advertiser to collect information about the distribution of the presented advertisement. Moreover, because the disclosed system integrates the online world with the bricks-and-mortar world, the system also enables advertisers to obtain a better understanding of consumer activities across both domains.

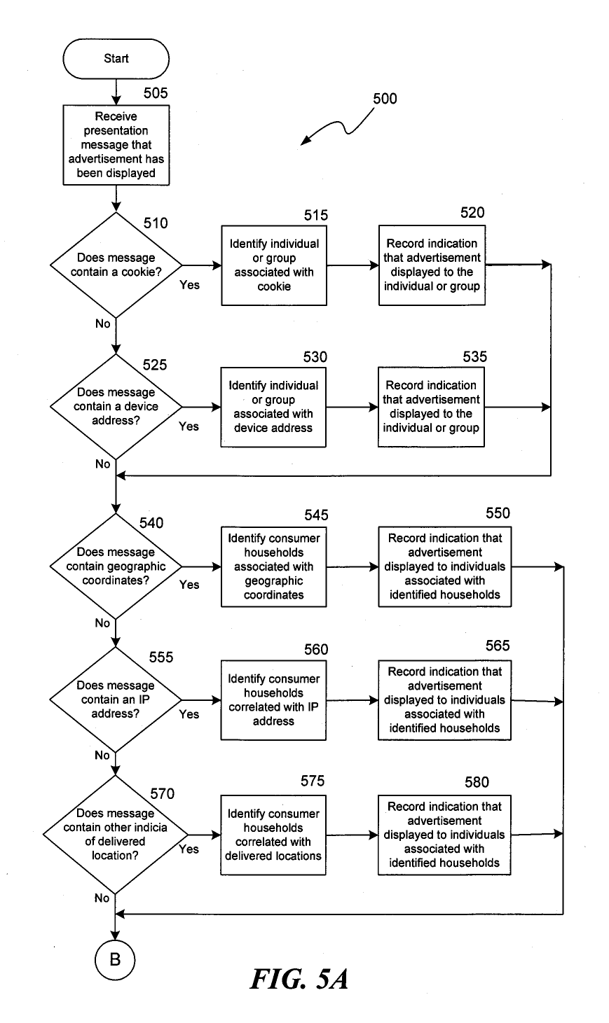

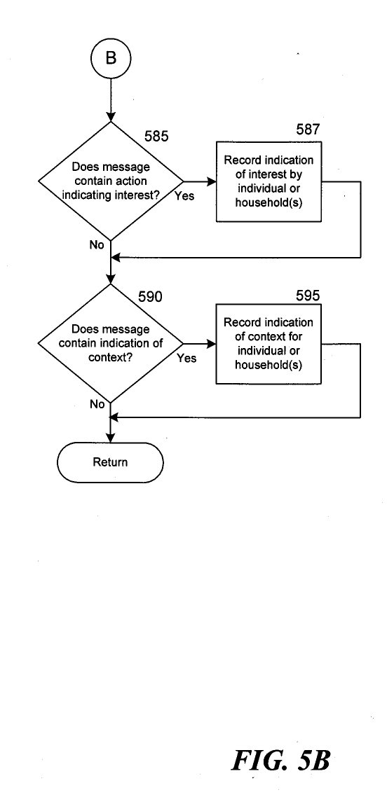

When a presentation message is received by the monitoring system 100, the monitoring system parses the message to identify the details surrounding the presented advertisement. FIG. 5A-5B is a flow chart of a process 500 to interpret a presentation message that is received when an electronic advertisement is displayed to, and selected by, a consumer or a consumer household. At a block 505, the monitoring system receives a presentation message from the computing system indicating that an electronic advertisement has been presented to a consumer. The presentation message is then processed to determine whether it can be identified as being associated with a consumer or consumer household. If not linked to a particular consumer or consumer household, the presentation message is also analyzed to determine the location of the computing device when the advertisement was displayed. The location of the computing device allows the presentation message to be linked with one or more households and the consumers within those households.

At a decision block 510, the monitoring system analyzes the presentation message to determine whether the presentation message includes a cookie. If the presentation message contains a cookie, processing continues to a block 515 where the monitoring system determines whether information in the detected cookie indicates that the cookie is likely associated with a single consumer (e.g., a consumer having a smart phone) or associated with a consumer household (e.g., multiple members of a family that share a home computer or television). At a block 520, the monitoring system stores an indication that the electronic advertisement was presented to the corresponding consumer or consumer household that is associated with that cookie. If the cookie is associated with a computing device typically used by a single consumer, the monitoring system records that the corresponding advertisement was presented to the consumer associated with the computing device. In contrast, if the cookie is associated with a computing device typically used by multiple consumers, the monitoring system records that the corresponding advertisement was presented to all members of the consumer household that is associated with the computing device.

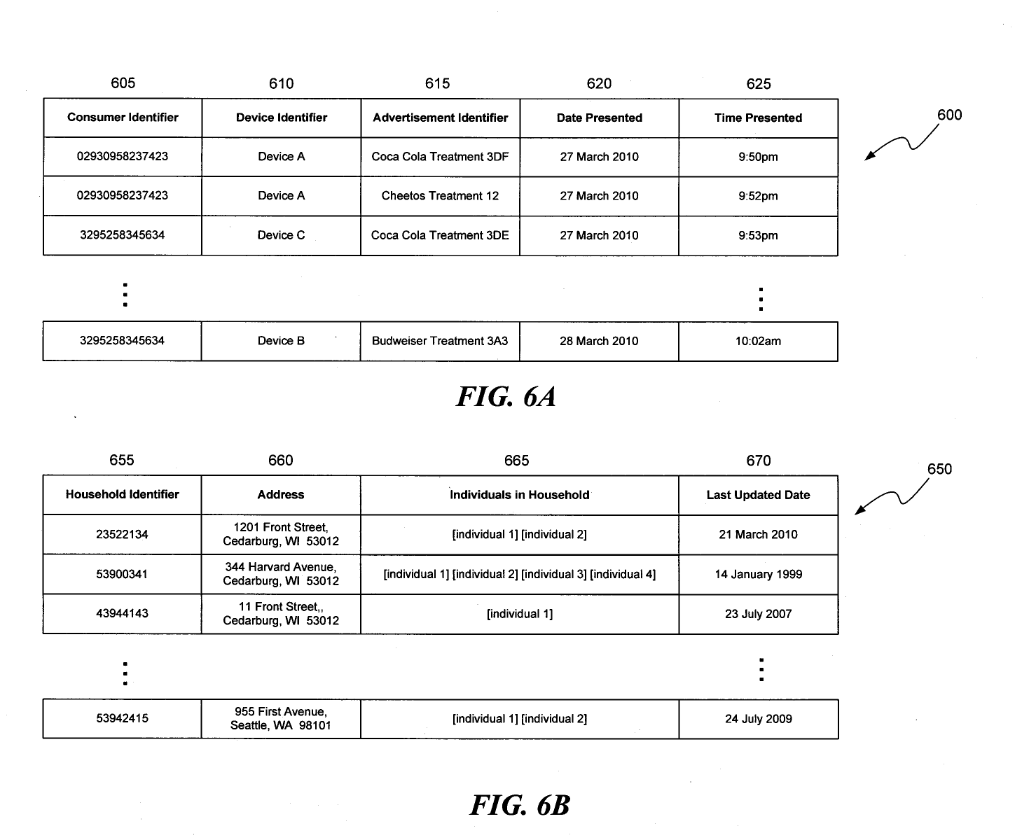

FIGS. 6A is a representative data table 600 in which the monitoring system 100 stores information about electronic advertisements that have been displayed to consumers. Each row in the data table 600 represents a consumer, and each column in the data table contains details of an electronic advertisement that was presented to the consumer. For example, a “consumer identifier” field 605 in the data table contains an identifier that uniquely identifies each consumer. In another data table (not shown), the consumer identifier is correlated with other details known about the consumer, such as the consumer's name, address, gender, demographic information, past purchase behavior, etc. A “device identifier” field 610 in the data table contains a record of the computing device on which the corresponding advertisement was shown. If the consumer has multiple computing devices, the monitoring system can thereby distinguish on which computing device the advertisement was displayed to the consumer. An “advertisement identifier” field 615 contains an identifier that uniquely identifies the advertisement that was displayed to the consumer. In addition to storing the brand that is being advertised, the table can also store the particular advertising treatment (i.e., which version of the advertisement) that was presented to the consumer. As will be described in additional detail herein, storing an indication of both the brand and the particular treatment allows the monitoring system to produce reports at both the brand or treatment level. The time at which the advertisement was presented to the consumer is recorded in a “date presented” field 620 and a “time presented” field 625. Only one row of the data table 600 is populated with data by the monitoring system 100 if a single consumer is associated with the cookie at block 520. In contrast, if multiple consumers are associated with the cookie at block 520 (i.e., if the cookie is associated with a household having multiple members), the monitoring system 100 will populate all rows of the data table 600 that are associated with those consumers. A data table that maintains a mapping between households and consumers in those households will be discussed in additional detail with respect to FIG. 6B.

Returning to FIG. 5A, if the presentation message contained a cookie, processing continues at a decision block 540. If the presentation message did not contain a cookie, at a decision block 525 the monitoring system analyzes the presentation message to determine whether the presentation message includes a device address, such as a Media Access Control (MAC) address, an International Mobile Subscriber Identity (“IMSI”), an International Mobile Equipment Identity (“IMEI”), a serial number, or the like. If the presentation message contains a device address, processing continues to a block 530 where the monitoring system determines whether the device address is likely associated with a single consumer (e.g., a consumer having a smart phone) or associated with a consumer household (e.g., multiple members of a family that share a home computer or television). At a block 535, the monitoring system stores an indication that the electronic advertisement was presented to the corresponding consumer or all members of the consumer household that is associated with the indicated device address. If no consumer or household is currently able to be identified as being associated with the device address, the advertisement is recorded as having been presented to an unknown consumer associated with the device address. When the consumer is subsequently identified (e.g., when the consumer subsequently registers with the system and a cookie is place on the consumer's computing device), the monitoring system is able to associate the past record of presented advertisements with the consumer. If the device address is associated with a computing device typically used by a single consumer, the monitoring system records that the corresponding advertisement was presented to the consumer associated with the computing device. In contrast, if the device address is associated with a computing device typically used by multiple consumers, the monitoring system records that the corresponding advertisement may have been presented to all members of the consumer household that are associated with the computing device.

If the presentation message did not contain a cookie or a device address, processing continues to a decision block 540. At decision block 540, the monitoring system 100 analyzes the presentation message to determine whether the presentation message includes geographic coordinates (e.g., latitude and longitude of the computing device). If the presentation message contains geographic coordinates, processing continues to a block 545 where the monitoring system determines the consumer households that are in proximity to the identified geographic coordinates. Such determination may be made by first translating the geographic coordinates into a street address using software or a service, such as PanOptic-X and InfoBase-X Consumer Insight Products provided by ACXIOM of Little Rock, Ark. The determined street address is then compared with a dataset of consumer household locations to identify the household or households that are within a certain distance to the location indicated by the geographic coordinates. For example, the monitoring system may identify the four households that are closest in proximity to the location identified by the geographic coordinates. FIG. 6B is a representative data table 650 in which the monitoring system 100 stores information about consumer households, such as the location and identity of consumers in each household. Each row in the data table 650 represents a tracked household, and each column in the data table contains details of that household. For example, a “household identifier” field 655 in the data table contains a unique identifier by which the monitoring system identifies a household. An “address” field 660 contains an address of the household, such as the street address of a house, townhome, duplex, apartment complex, military housing, etc. An “individuals in household” field 665 contains a list of those individuals that are identified as being associated with each household. The identified individuals may be identified using the unique identifier assigned to each consumer or other link to table 600. Finally, a “last updated date” field 670 contains the most recent date that the household information was verified.

Returning to FIG. 5A, at a block 550 the monitoring system stores an indication that the electronic advertisement was presented to all consumers that are located in the identified households. A household is envisioned as the primary unit by which to track the presentation of advertisements because it is a unit that advertisers and marketing professionals are familiar with using to study populations of consumers. It will be appreciated, however, that the monitoring system may track the presentation of advertisements in any other unit. For example, the monitoring system may divide a population area into a 1-mile grid, into city blocks, into zip codes, or may select any other size regions that provide beneficial data to an advertiser. The geographic coordinates are used by the monitoring system to determine the geographic unit that is implicated by the geographic coordinates, and then to identify all consumers that fall within the determined geographic unit based on households within that geographic unit. Following recordation of the presentation of the advertisement, processing halts.

If the message does not contain geographic coordinates at decision block 540, processing continues to a decision block 555. At decision block 555, the monitoring system 100 analyzes the presentation message to determine whether the presentation message includes an IP address associated with the computing device. If the presentation message contains the IP address, processing continues to a block 560 where the monitoring system determines the households that are associated with the IP address. The monitoring system may determine the households by first identifying a zip code or other geographic area associated with the IP address using commercial software or service such as the GeoSelect service offered by GEOBYTES. While the IP address does not always accurately reflect the location of the computing device, the IP address can serve as an approximate indicator of location when no better location information is contained in the presentation message. Once the approximate geographic area associated with the IP address is determined, the monitoring system determines the households that are located within the geographic area by correlating the address of each household with the geographic area. At a block 565, the monitoring system stores an indication that the electronic advertisement was presented to each consumer associated with an identified household within the geographic area. Following recordation of the presentation of the advertisement, processing halts.

If the message does not contain an IP address at decision block 555, processing continues to a decision block 570. At decision block 570, the monitoring system 100 analyzes the presentation message to determine whether there is any other information contained in the presentation message that may be interpreted as indicia of the location of the computing device (e.g., coding reflecting an identity of an Internet service provider). If the presentation message contains any indicia of location, processing continues to a block 560 where the monitoring system determines the households that found at the identified location using the previously-described techniques. At a block 580, the monitoring system stores an indication that the electronic advertisement was presented to all consumers that are associated with the identified households. Following recordation of the presentation of the advertisement, processing continues to a block 585.

At a decision block 585, the monitoring system 100 analyzes the presentation message to determine whether information is contained in the presentation message that reflects an action indicating interest by the consumer to the corresponding advertisement. Such action may be, for example, the consumer's selection of the advertisement by clicking-on the advertisement. If an action indicating interest in the advertisement is detected in the presentation message, at a block 587 the monitoring system records the interest in association with the previously-identified consumer, household, or households to which the advertisement was presented. Processing then continues to a decision block 590.

At a decision block 590, the monitoring system 100 analyzes the presentation message to determine whether information is contained in the presentation message that reflects the context in which the corresponding advertisement was presented to the consumer. The context may be represented, for example, by the URL or URI of the content that is currently being viewed by the consumer, or the browser history of the consumer. If information reflecting a consumer action is contained in the presentation message, at a block 595 the monitoring system records the interest in association with the previously-identified consumer, household, or households to which the advertisement was presented. Processing then returns.

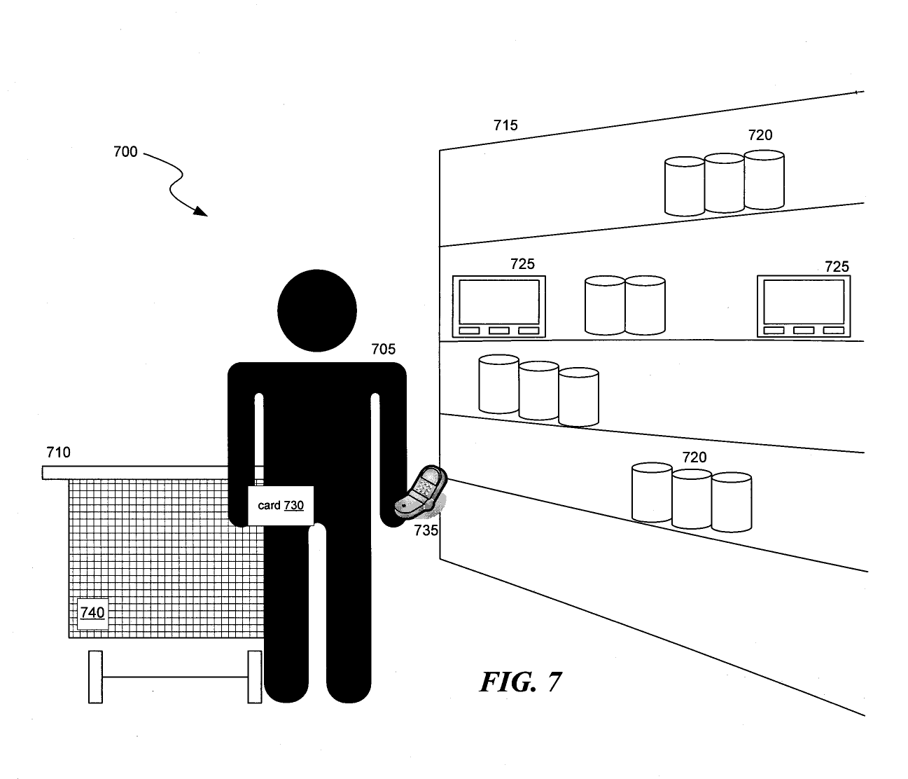

As presentation messages are received by the monitoring system 100, the monitoring system populates data table 600 with data reflecting the presentation of electronic advertisements to consumers. As data table 600 is continuously being populated by the monitoring system 100, the monitoring system is able to provide slices of the stored data to allow advertisements to be targeted to consumer in retail environments. FIG. 7 is a perspective view of a retail environment 700 containing an advertising system with display devices 725 that present advertising content to consumers 705 that are visiting the retail environment. The retail environment may be any environment in which consumers purchase products, such as a grocery store, a drug store, an office supply store, a hardware store, an auto parts store, etc. Such retail environments normally have one or more rows of shelving 715 that allow the retailer to display various products 720 that are available for purchase by the consumer. To facilitate the purchase of products, the retailer may offer shopping carts 710 or other baskets or tote bags (not shown) that allow the consumer to carry those products that are intended to be purchased.

Deployed within the retail environment 700 is an advertising system (not shown) that allows advertising content to be displayed to consumers in a targeted and trackable manner. The retail environment 700 is divided into a number of detection regions and display zones. A detection region is a region in which the presence of a marker associated with a consumer may be detected and the location of the marker in the detection region determined. The marker may be embedded in or attached to a card 130 (e.g., a store loyalty card, a credit card, a driver's license, etc.) that this carried by the consumer, the marker may be embedded in an identification component 140 that is attached to the shopping cart 110, basket, or bag carried by the consumer, or the consumer may have a marker attached to or embedded in a mobile phone 135 or other portable device that is carried by the consumer (e.g., in a SIM card that is inserted into a mobile phone or other device). When the marker is detected in proximity to a display device 725, the advertising system presents targeted advertising to the consumer on the display device. Further information about a representative advertising system suitable for installation in the retail environment may be found in U.S. patent application Ser. No. 12/557,383, filed Sep. 10, 2009, and entitled “SYSTEM AND METHOD FOR THE SERVICE OF ADVERTISING CONTENT TO A CONSUMER BASED ON THE DETECTION OF ZONE EVENTS IN A RETAIL ENVIRONMENT.”

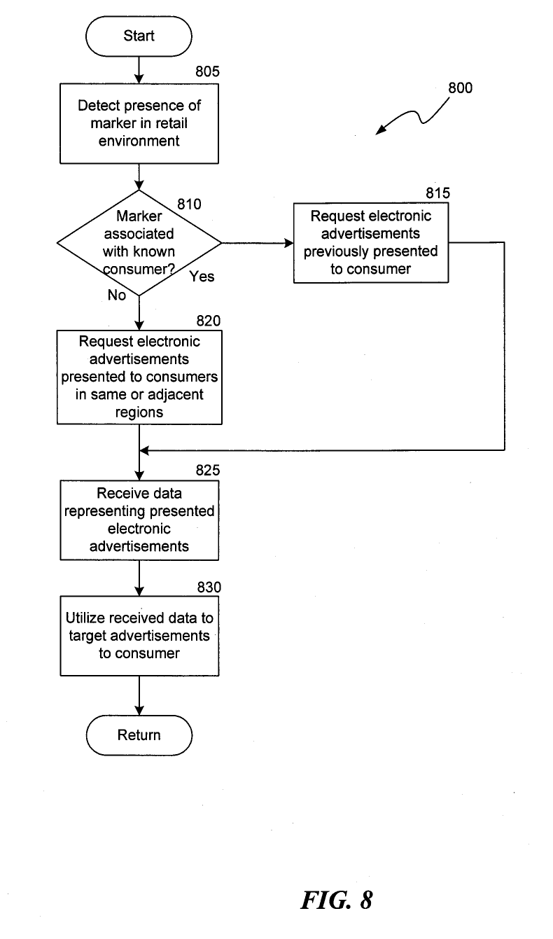

In order to deliver a targeted advertisement in the retail establishment, the advertising system utilizes information about electronic advertisements that were previously presented to a consumer or consumers. FIG. 8 is a flow chart of a process 800 that is implemented by the advertising system to request information about electronic advertisements that were previously-delivered to consumers for purposes of targeting advertisements to consumers in the retail environment. At a block 805, the advertising system detects the presence of a marker in the retail environment. At a decision block 810, the advertising system determines whether the marker is associated with a known consumer. Representative methods for identifying known consumers in the retail establishment are described in U.S. patent application Ser. No. 12/621,414, filed Nov. 18, 2009, and entitled “SYSTEM AND METHOD FOR THE CORRELATION OF MOBILE DEVICES WITH MARKERS USED BY A CONTENT DELIVERY SYSTEM IN A RETAIL ENVIRONMENT.”

If the marker is associated with a known consumer at decision block 810, at a block 815 the advertising system requests the monitoring system 100 for data which reflects electronic advertisements that were previously presented to the consumer. If the marker is not associated with a known consumer at decision block 810, at a block 820 the advertising system requests the monitoring system 100 for data which reflects electronic advertisements that were previously presented to consumers in the same or adjacent geographies to the retail environment. For example, the advertising system may request data reflecting electronic advertisements that were presented to consumers in the same zip code as the retail environment, that were presented to consumers that live within a mile of the retail environment, or that were presented to consumers in adjacent zip codes to the zip code containing the retail environment.

At a block 825, the advertising system receives data from the monitoring system 100 which reflects the electronic advertisements that were presented to the identified consumer or to consumers in the identified geographies. At a block 830, the advertising system uses the received data to target advertising content to consumers in the retail environment. For example, the advertising system may utilize the record of electronic advertisements that have been presented to a consumer or consumers to present the same or complementary advertising content within the retail environment as previously described herein.

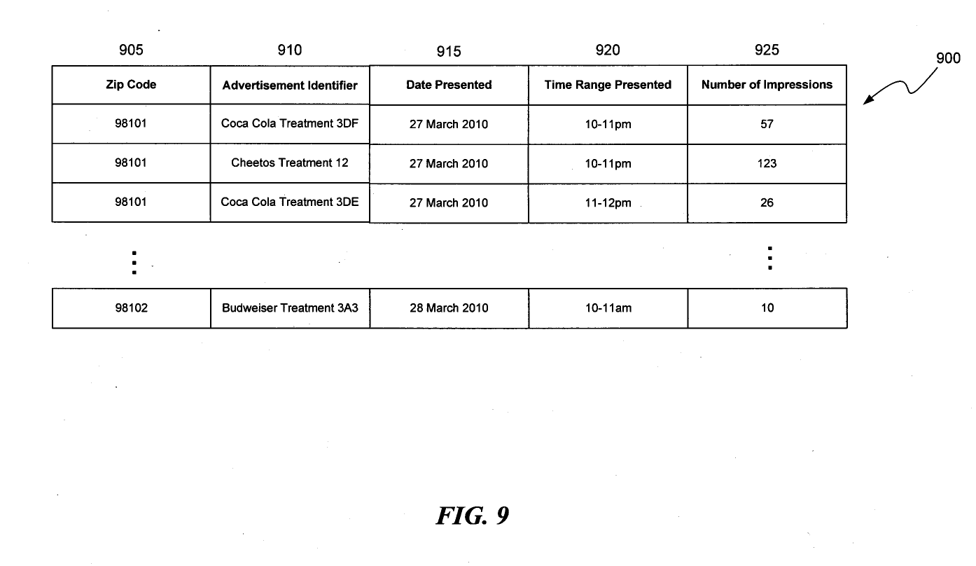

It will be appreciated that while the process 800 contemplates that the advertising system will make a request to the monitoring system 100 when a marker is detected, the advertising system may instead download the representative data on a periodic basis. For example, on a daily or hourly basis the advertising system may download data relating to known consumers that visit the store, or download aggregate data reflecting the presentation of electronic advertisements to consumers in the same and surrounding geographies. The frequency of such downloads may depend on the rate of change of advertising, the desired timeliness of targeted advertisements, and other factors. Representative aggregate data that is maintained by the monitoring system is depicted in FIG. 9. FIG. 9 is a representative table 900 in which the monitoring system 100 has stored aggregate data about electronic advertisements that have been displayed to consumers in particular geographic areas. Each row in the data table 900 represents a tracked geographic area, and each column in the data table contains details of an electronic advertisement that was presented to consumers in that geographic area. For example, a “zip code” field 905 in the data table contains the zip code in which advertisements are being tracked. An “advertisement identifier” field 910 contains an identifier that uniquely identifies the advertisement that was displayed to the consumer. In addition to storing the brand that is being advertised, the table can also store the particular advertising treatment (i.e., which version of the advertisement) that was presented to the consumer. As was described in additional detail herein, storing an indication of both the brand and the particular treatment allows the monitoring system to produce reports at both the brand or treatment level. The time range during which advertisements were presented is recorded in a “date presented” field 915 and a “time range presented” field 920. The time range presented may be longer periods (e.g., a day, a week) or shorter periods (e.g., three-hour periods, one-hour periods) depending on the desired amount of fidelity of the monitoring system. Finally, a “number of impressions” field 925 contains the aggregate number of times that the identified advertisement was presented to consumers in the identified geographic territory. In the depicted example, the CHEETOS brand snack advertisement was displayed 123 times during the 10-11 pm time frame in zip code 98101. The monitoring system populates the data table 900 using the record of advertisements presented to consumers in table 600 in conjunction with the composition and location of households contained in table 650

It will be appreciated that while the monitoring system 100 and the advertising system are described as different systems herein, the function of both systems may be combined into a single, unitary, system. That is, the functionality of the monitoring and advertising systems may be combined into a single system that provide the monitoring and targeting capabilities described herein.

After the advertising system presents targeted advertising content to consumers in the retail environment, the advertising system may monitor the effectiveness of the advertising content, such as by detecting the lift in sales that are generated as the result of such advertising. Data characterizing the effectiveness of the targeted advertising content may be merged with the data from data tables 600 and 650 and provided to advertisers. Such merged data allows advertisers to holistically assess the performance of advertising treatments, including advertisements that are delivered electronically via computing devices and advertising content that is delivered via an in-store network. By holistically assessing the performance of advertising treatments, advertisers may adjust their advertising strategies in order to maximize the performance of advertising campaigns.

In the foregoing description an advertisement was associated with a unique identifier to allow the monitoring system 100 to track the identity of the presented advertisement. In some embodiments, rather than an advertisement being associated with a unique identifier, the advertiser may characterize the advertisement in a way that can be interpreted by the monitoring system 100 without having to rely upon an identifier. For example, the advertiser may use a Resource Description Framework (RDF) in XML form to tag the advertisement and any associated consumer information that is being transmitted to the monitoring system after selection of an advertisement. Such tagged information sent to the monitoring system may resemble, for example, the following:

<rdf:RDF xmlns:rdf=“http://www.w3.org/1999/02/22-rdf-syntax-ns#”

xmlns:ns=“http://www.visbrands.com/#”>

<ns:SaltySnacks
rdf:about=“http://www.visbrands.com/#SaltySnacks”>

<ns:hasBrand
rdf:resource=“http://www.visbrands.com/#Lays” />
<ns:hasProduct>

<rdf:Description
rdf:about=“http://www.visbrands.com/#bbqchips”>

<ns:hasOffer
rdf:resource=“http://www.visbrands.com/#laysbbq” />

</rdf:Description>

</ns:hasProduct>
</ns:hasBrand>

</ns:SaltySnacks>
<ns:UserProfile rdf:about=“http://www.visbrands.com/#UserProfile”>

<ns:myInterests
rdf:about=“http://www.visbrands.com/#myInterests”>

<ns:myActions
rdf:about=“http://www.visbrands.com/#myActions”>
</ns:myActions>

</ns:myInterests>

</ns:UserProfile>

</rdf:RDF>

In the provided example, the tagged information indicates to the monitoring system 100 that an advertisement for LAYS BBQ chips was presented to the identified consumer. The monitoring system may utilize the received information to track the presentation of advertisements as previously described herein.

From the foregoing, it will be appreciated that specific embodiments of the invention have been described herein for purposes of illustration, but that various modifications may be made without deviating from the spirit and scope of the invention. For example, the depicted flow charts may be altered in a variety of ways. The order of the steps may be rearranged, steps may be performed in parallel, steps may be omitted, or other steps may be included. While FIGS. 6A, 6B, and 9 depict tables whose contents and organization are designed to make them more comprehensible by a human reader, those skilled in the art will appreciate that the actual data structure(s) used by the system to store this information may differ from the tables shown, in that they, for example, may be organized in a different manner, may contain more or less information than shown, may be compressed and/or encrypted, and may be optimized in a variety of ways. Accordingly, the invention is not limited except as by the appended claims.

I/We claim:

1. A computer-implemented method of tracking advertisements that are electronically presented to consumers on computing devices and providing information associated with the tracked advertisements to allow advertising content to be targeted to consumers that visit retail establishments, the method comprising:
receiving messages indicating that electronic advertisements have been presented to consumers on computing devices, each message containing information about the identity of a presented electronic advertisement and information reflecting a location of a computing device when the electronic advertisement was presented;
using the information reflecting the location of the computing device to associate each presented electronic advertisement with one or more consumer households;
storing in a data storage area information characterizing the presented electronic advertisements, the stored information including information about the identity of the electronic advertisements and the consumer households in which the electronic advertisements were presented;
receiving a request for data characterizing the presentation of electronic advertisements within a particular region from an advertising system that provides advertising content for a network of display devices in a retail establishment;
in response to the request for data, accessing the stored information characterizing the presented electronic advertisements and generating responsive data which characterizes the presented electronic advertisements within the requested particular region; and
providing the responsive data to the advertising system to allow targeted advertising content to be delivered to consumers in the retail establishment.

2. The computer-implemented method of claim 1, wherein the information reflecting a location of a computing device is geographic coordinates of the computing device.

3. The computer-implemented method of claim 1, wherein the information reflecting a location of a computing device is an IP address associated with the computing device.

4. The computer-implemented method of claim 1, wherein each received message further comprises information about the identity of the computing device on which the electronic advertisement was presented.

5. The computer-implemented method of claim 4, wherein the information about the identity of the computing device is a MAC address associated with the computing device.

6. The computer-implemented method of claim 1, wherein each received message further comprises information about the identity of a user associated with the computing device on which the electronic advertisement was presented.

7. The computer-implemented method of claim 6, wherein the information about the identity of the user is stored in a cookie on the computing device.

8. The computer-implemented method of claim 1, further comprising storing times associated with the presentation of the electronic advertisements

9. The computer-implemented method of claim 8, wherein the time associated with the presentation of an electronic advertisement is reflected as a range of times.

10. The computer-implemented method of claim 1, wherein the information about the identity of an electronic advertisement includes an indication of a brand and a treatment.

11. The computer-implemented method of claim 1, wherein the particular region is a zip code.

12. The computer-implemented method of claim 1, wherein the particular region is a geography surrounding the retail establishment.

13. The computer-implemented method of claim 1, further comprising:
receiving information from the advertising system characterizing the performance of the targeted advertising content;
selectively merging the information from the advertising system charactering the performance of the targeted advertising content with the stored information characterizing the presented electronic advertisements; and
providing the merged information to advertisers to allow the advertisers to assess the effectiveness of advertising campaigns.

14. The computer-implemented method of claim 1, wherein the computing device is a mobile computing device.

15. The computer-implemented method of claim 1, wherein the messages are received from a script running on each computing device.

16. The computer-implemented method of claim 15, wherein the script is inserted into an advertisement by an advertiser.

17. A system for tracking advertisements that are electronically presented to consumers on computing devices and providing data pertaining to the tracked advertisements to allow advertising content to be targeted to consumers that visit retail establishments, the system comprising:
a communications module that is configured to receive messages indicating that electronic advertisements have been presented to consumers on computing devices, each message containing information about the identity of a presented electronic advertisement and information reflecting a location of a computing device when the electronic advertisement was presented;
a management module that is configured to:
use the information reflecting the location of the computing device to associate each presented electronic advertisement with one or more consumer households; and
store in a data storage area information characterizing the presented electronic advertisements, the stored information including information about the identity of the electronic advertisements and the consumer households in which the electronic advertisements were presented; and
a reporting module that is configured to:
receive a request for data characterizing the presentation of electronic advertisements within a particular region from an advertising system that provides advertising content for a network of display devices in a retail establishment;
in response to the request for data, access the stored information characterizing the presented electronic advertisements and generate responsive data which characterizes the presented electronic advertisements within the requested particular region; and
provide the responsive data to the advertising system to allow targeted advertising content to be delivered to consumers in the retail establishment.

18. The system of claim 17, wherein the information reflecting a location of a computing device is geographic coordinates of the computing device.

19. The system of claim 17, wherein the information reflecting a location of a computing device is an IP address associated with the computing device.

20. The system of claim 17, wherein each received message further comprises information about the identity of the computing device on which the electronic advertisement was presented.

21. The system of claim 20, wherein the information about the identity of the computing device is a MBC address associated with the computing device.

22. The system of claim 17, wherein each received message further comprises information about the identity of a user associated with the computing device on which the electronic advertisement was presented.

23. The system of claim 22, wherein the information about the identity of the user is stored in a cookie on the computing device.

24. The system of claim 17, wherein the management module is further configured to store times associated with the presentation of the electronic advertisements

25. The system of claim 24, wherein the time associated with the presentation of an electronic advertisement is reflected as a range of times.

26. The system of claim 17, wherein the information about the identity of an electronic advertisement includes an indication of a brand and a treatment.

27. The system of claim 17, wherein the particular region is a zip code.

28. The system of claim 17, wherein the particular region is a geography surrounding the retail establishment.

29. The system of claim 17, wherein the reporting module is further configured to:
receive information from the advertising system characterizing the performance of the targeted advertising content;
selectively merge the information from the advertising system charactering the performance of the targeted advertising content with the stored information characterizing the presented electronic advertisements; and
provide the merged information to advertisers to allow the advertisers to assess the effectiveness of advertising campaigns.

30. The system of claim 17, wherein the computing device is a mobile computing device.

31. The system of claim 17, wherein the messages are received from a script running on each computing device.

32. The system of claim 31, wherein the script is inserted into an advertisement by an advertiser.

33. A non-transitory computer-readable medium containing instructions that, when executed on a processor, cause the processor to implement a method of tracking advertisements that are electronically presented to consumers on computing devices and providing information associated with the tracked advertisements to allow advertising content to be targeted to consumers that visit retail establishments, the method comprising:
receiving messages indicating that electronic advertisements have been presented to consumers on computing devices, each message containing information about the identity of a presented electronic advertisement and information reflecting a location of a computing device when the electronic advertisement was presented;
using the information reflecting the location of the computing device to associate each presented electronic advertisement with one or more consumer households;
storing in a data storage area information characterizing the presented electronic advertisements, the stored information including information about the identity of the electronic advertisements and the consumer households in which the electronic advertisements were presented;
receiving a request for data characterizing the presentation of electronic advertisements within a particular region from an advertising system that provides advertising content for a network of display devices in a retail establishment;
in response to the request for data, accessing the stored information characterizing the presented electronic advertisements and generating responsive data which characterizes the presented electronic advertisements within the requested particular region; and
providing the responsive data to the advertising system to allow targeted advertising content to be delivered to consumers in the retail establishment.

34. The computer-readable medium of claim 33, wherein the information reflecting a location of a computing device is geographic coordinates of the computing device.

35. The computer-readable medium of claim 33, wherein the information reflecting a location of a computing device is an IP address associated with the computing device.

36. The computer-readable medium of claim 33, wherein each received message further comprises information about the identity of the computing device on which the electronic advertisement was presented.

37. The computer-readable medium of claim 33, wherein each received message further comprises information about the identity of a user associated with the computing device on which the electronic advertisement was presented.

38. The computer-readable medium of claim 33, wherein the particular region is a zip code.

39. The computer-readable medium of claim 33, wherein the particular region is a geography surrounding the retail establishment.

40. The computer-readable medium of claim 33, wherein the messages are received from a script running on each computing device.
